(19) United States
(12) Patent Application Publication
(10) Pub. No.: US 2004/0058050 A1
(43) Pub. Date: Mar. 25, 2004

(54) Herbal sweetening composition

(76) Inventor: Peilin Guo, Gardena, CA (US)

Correspondence Address: MCCARTER & ENGLISH LLP, CITYPLACE I, 185 ASYLUM STREET, HARTFORD, CT, 06103, US

(21) Appl. No.: 10/254,333

(22) Filed: Sep. 25, 2002

(51) Int. Cl. A23L 1/236

(52) U.S. Cl. 426/615

(57) ABSTRACT

An herbal sweetener composition is used to sweeten foods or beverages. The herbal sweetener includes extract of Lo Han Kuo fruit, a sugar alcohol, and a non-digestible soluble carbohydrate. In a preferred embodiment, the sugar alcohol is xylitol and the non-digestible soluble carbohydrate is an indigestible maltodextrin or a non-digestible oligosaccharide. Excipients or other ingredients may be added to the composition to impart desired characteristics or properties. Methods of using the herbal sweetener to sweeten foods or beverages are also provided.

The present invention relates generally to an herbal sweetening composition comprising extract of Lo Han (Momordica grosvenorii, or Siraitia grosvenorii) fruit (or Lo Han Kuo), a sugar alcohol, such as xylitol, and a non-digestible soluble carbohydrate, such as guar gum, carragennan gum, indigestible maltodextrin, or a non-digestible oligosaccharide. The composition can be used to reduce or replace sucrose in foods and beverages. The present invention also relates to methods of using the composition to sweeten foods or beverages.

### BACKGROUND OF THE INVENTION

Sucrose, the substance that comprises refined table sugar, has been used to sweeten foods for many years. While sucrose is easy to use to sweeten a variety of foods, it is relatively high in calories, low in nutrients, causes dental cavities and causes a surge in blood sugar and blood insulin levels. Sucrose intake must be carefully controlled in diabetics, people with insulin resistance and people who are overweight, and excessive ingestion of sucrose in non-diabetics can result in a variety of adverse health effects, including dental caries and excessive weight gain. In an effort to reduce these health effects, replacements for sucrose as a food sweetener have been sought for many years.

Several artificial and herbal sweeteners have been used as substitutes for refined sugar in foods. For example, cyclamates, saccharin and aspartame have each been used as substitutes for refined sugar in food and beverages. Although several substances or combinations of substances, both artificial and herbal, have been used as sugar substitutes, the previous sugar substitutes have one or more disadvantages. Many artificial sweeteners leave an aftertaste, which in many cases is bitter and therefore reduces the effectiveness of the substance as a sweetener. In addition, some of the previous refined sugar substitutes cause an increase in blood sugar levels, making them unsuitable for foods for diabetics or for those on a low carbohydrate diet.

One herbal substance that has been used as a substitute for refined sugar is Lo Han Kuo extract. Lo Han Kuo is the fruit of the plant Momordica grosvenori (Siraitia grosvenorii), belonging to the family of Cucurbitacae. Lo Han fruit has been used for thousands of years in Chinese medicine to treat colds, coughs, sore throats, stomach distress, constipation and diarrhea. Lo Han fruit may also act as an antioxidant, and it has been reported to have anti-microbial or preservative properties in foods.

Lo Han Kuo contains naturally occurring mogrosides, or terpene glycosides, which can be used as a sweetener. Using water and/or alcohol extraction technology, the concentrated extract of the Lo Han Kuo fruit can be up to 200-300 times as sweet as refined table sugar. Accordingly, Lo Han Kuo extract can be used as a sweetener for people who need to limit their intake of refined sugars or carbohydrates. In addition, use of Lo Han Kuo extract as a sweetener can minimize the risk of dental cavities.

Lo Han Kuo extract is easy to dissolve in water or alcohol solutions, and it has excellent stability when exposed to heat or cold. These properties make Lo Han Kuo extract useful as a sweetener in a variety of hot or cold foods and beverages.

Although Lo Han Kuo extract is effective for use as a sweetener, the extract can leave an unpleasant, bitter aftertaste. Certain mogroside compounds present in Lo Han Kuo, particularly in the dried fruit, can cause a bitter taste. Several prior compositions have been formulated to try to reduce or mask the bitter aftertaste. For example, a product marketed under the name Sugar Not contained Lo Han Kuo extract, soluble fiber and crystalline fructose. This combination still can result in an unpleasant aftertaste. Moreover, there is evidence that fructose can produce a delayed dietary effect by increasing the insulin response in the body and the activity of blood lipids.

Accordingly, it is an object of the present invention to provide an herbal sweetener that has a minimal aftertaste and does not produce undesirable effects when consumed. Other objects and advantages of the composition described herein will be readily apparent to those skilled in the art based upon the description of the invention provided below.

### SUMMARY OF THE INVENTION

The present invention provides, in one aspect, compositions which can be used as a replacement for sugar based sweeteners i.e. (sucrose, fructose, and other sugars) in foods and beverages. The compositions comprise Lo Han Kuo extract, a sugar alcohol and a non-digestible soluble carbohydrate. In one embodiment, the sugar alcohol is xylitol and the non-digestible soluble carbohydrate is either indigestible maltodextrin or Inulin-FOS (FructoOligoSaccharides). The xylitol reduces or eliminates the aftertaste typically associated with Lo Han Kuo, while providing a relatively low calorie sweetener. The indigestible maltodextrin or Inulin-FOS provides bulk to the herbal sweetener to improve its ability to be used in foods without adding many calories to the sweetener, and also balances the overall taste profile of the sweetener.

In one embodiment, the herbal sweetener is comprised of about 5% by weight Lo Han Kuo extract, about 40% by weight xylitol and about 55% by weight of a non-digestible soluble carbohydrate, such as Fibersol 2®, an indigestible maltodextrin, or Inulin-FOS. It should be understood that the invention is not limited in this regard, and the relative amounts of these ingredients can be varied to achieve similar results. The herbal sweetener may be provided in dry powder form or in a liquid form as desired. Additional ingredients, such as for example excipients or fillers, may be added to the composition to impart desired characteristics or properties for chosen uses of the sweetener.

Among the advantages of the composition is that the xylitol has a cooling effect on the tongue that reduces or eliminates the bitter taste that may be caused by Lo Han Kuo extract. A further advantage of the invention is that it has fewer calories per gram than sucrose, or fructose, and, because it is much sweeter than sucrose or fructose, a smaller amount of the composition can be used to achieve the same level of sweetness in foods and beverages, further reducing the calorie intake for desired level of sweetness.

In a second aspect of the invention, methods for using the composition to sweeten foods or beverages are provided. Because the compositions are relatively stable when exposed to heat or cold, they can be used in a variety of hot or cold foods and beverages, including dry mixes, baked products, candies, and ice cream.

Other advantages of the present invention will become apparent to those skilled in the art in view of the following detail description of the invention.

### DETAILED DESCRIPTION OF THE INVENTION

The present invention is directed to an herbal sweetening composition which can be used as a substitute or replacement for sucrose (or other conventional sugar) based sweeteners, and to methods for using the herbal sweetener in foods or beverages. The compositions of the present invention comprise Lo Han Kuo extract, a sugar alcohol and a non-digestible soluble carbohydrate.

Lo Han Kuo extract contains naturally occurring mogrosides, or terpene glycosides, which act as a very intense sweetener. Concentrated mogrosides can be 200-300 times as sweet as sucrose (i.e. table sugar). While concentrated mogrosides can acts as a very intense sweetener, certain mogrosides can cause a bitter aftertaste. Accordingly, it is desirable to combine the Lo Han Kuo extract with substances that can reduce or eliminate the bitter taste that may be associated with Lo Han Kuo.

Sugar alcohols are non-sucrose sweeteners which may be used to sweeten foods and beverages, while reducing or eliminating the adverse health effects than can occur with sucrose. Sugar alcohols such as xylitol can produce a cooling or soothing effect on the tongue, which can reduce or eliminate the bitter taste associated with Lo Han extract. Sugar alcohols typically have fewer calories than sucrose for an equivalent amount of sweetening in foods and beverages. In addition, sugar alcohols do not promote tooth decay, and they are acceptable for use in the diets of diabetics. Sugar alcohols that may be used in combination with extract of Lo Han Kuo fruit include, for example, xylitol, sorbitol, maltitol or mannitol.

A non-digestible soluble carbohydrate is added to the composition to provide bulk to the sweetener. As used herein and in the claims, the term “non-digestible soluble carbohydrate” means a material that is substantially indigestible by human enzymes, that has a low calorie value derived from its metabolites, and that is acceptable for use in foods, beverages or any type of product consumed by humans. Examples of non-digestible soluble carbohydrates suitable for use in the present invention include soluble fibers, such as guar gum or caragennan gum, indigestible maltodextrins, such as Fibersol 2®, or non-digestible oligosachharides, such as Inulin-FOS. The invention is not limited in this regard and any non-digestible soluble carbohydrate suitable for human consumption known to those skilled in the art can be used in the composition. Preferably, the non-digestible bulk material does not add any calories, or adds a negligible amount of calories, to the composition. In a preferred embodiment, the non-digestible soluble carbohydrate is Fibersol 2®, available from Matsutani America, Inc. Fibersol 2® may be used to add bulk to the herbal sweetener without adding any calories.

The herbal sweeteners of the present invention may include additional ingredients to impart desired properties or characteristics to the composition. For example, an excipient such as silicon dioxide may be added to the composition.

In one embodiment of the invention, the herbal sweetener comprises between about 1% and 90% by weight extract from Lo Han Kuo fruit, between about 5% and 90% by weight of a sugar alcohol, and between about 5% and 94% by weight of a non-digestible soluble carbohydrate. Preferably, the extract from the Lo Han Kuo fruit contains at least about 80% by weight mogroside. The invention is not limited in this regard, however, and Lo Han Kuo fruit extract containing greater or lesser amounts of mogroside may be used.

Preferably, xylitol is used as the sugar alcohol and indigestible maltodextrin, or an indigestible oligosaccharaide, such as Inulin-FOS, is used as the non-digestible soluble carbohydrate. Xylitol (C₅H₁₂O₅) occurs naturally in many fruits and vegetables. Xylitol has approximately equivalent sweetness as sucrose with one-third fewer calories (4 calories/g for sucrose vs. 2.4 calories/g for xylitol). Xylitol dissolves quickly and produces a cooling sensation in the mouth. Xylitol is a sugar alcohol found in berries, fruit, vegetables and mushrooms. Xylitol has been shown to reduce dental cavities and has a very low glycemic index. When combined with Lo Han Kuo extract, xylitol was unexpectedly found to prevent the unpleasant aftertaste often associated with Lo Han Kuo sweeteners.

In a preferred embodiment, the herbal sweetener comprises between about 1% and 10% by weight extract from Lo Han Kuo fruit, between about 30% and 49% by weight xylitol, and between about 50% and 60% by weight Fibersol-2®, an indigestible maltodextrin. Alternatively, an indigestible oligosaccharide, such as Inulin-FOS may be used in place of the indigestible maltodextrin. In a preferred embodiment, the herbal sweetener has the following composition:

| | |
|---|---|
| Lo Han Kuo extract (as 80% mogroside) | 100 mg |
| Fibersol-2 ® (indigestible maltodextrin) | 1100 mg |
| Xylitol | 800 mg |
| Total weight per serving | 2000 mg(2g) |

In another preferred embodiment, the herbal sweetener has the following composition:

| | |
|---|---|
| Lo Han Kuo extract (as 80% mogroside) | 100 mg |
| Inulin-FOS | 1100 mg |
| Xylitol | 800 mg |
| Total weight per serving | 2000 mg(2g) |

As will be apparent to a person skilled in the art, the relative amounts of the ingredients can be varied as desired to produce an herbal sweetener that is particularly suited to a particular application.

The herbal sweetener may be provided in a dry powder form which can be added to a food or beverage to sweeten the food or beverage to the desired taste. Because the herbal sweetener has excellent stability when exposed to heat, it may be used in baked products or included in mixes used to make baked foods such as breads or cakes. Alternatively, the herbal sweetener can be dissolved in a liquid carrier, such as water.

The herbal sweetener can be used to sweeten dry products, such as baking mixes, meal replacements, protein powders, low sugar meal substitutes, nutritional supplements or other nutritional products. The herbal sweetener may also be added to baked items, either before or after baking, or it may be used as a sweetener in candies, bars, ice creams, smoothies, or other sweet items. When used in food items, the herbal sweetener is added in a sufficient amount to achieve the desired level of sweetness for the particular food or beverage item being sweetened.

As will be recognized by those of ordinary skill in the pertinent art based on the teachings herein, numerous changes and modifications may be made to the above-described and other embodiments of the invention without departing form its scope as defined in the claims. For example, additional ingredients may be added, or similar ingredients may be substituted for one or more of the ingredients described. Accordingly, this detailed description of preferred embodiments is to be taken in an illustrative as opposed to a limiting sense.

I claim:

1. A composition for use as a sweetener in foods or beverages comprising:
(a) extract from Lo Han Kuo fruit;
(b) a sugar alcohol; and
(c) a non-digestible soluble carbohydrate.

2. The composition of claim 1, wherein the composition comprises from about 1% to about 90% by weight extract from Lo Han Kuo fruit, from about 5% to about 90% by weight of a sugar alcohol, and from about 5% to about 94% by weight of a non-digestible soluble carbohydrate.

3. The composition of claim 2, wherein the extract from the Lo Han Kuo fruit comprises at least 50% mogrosides.

4. The composition of claim 2, wherein the sugar alcohol is xylitol and the non-digestible soluble carbohydrate is an indigestible maltodextrin.

5. The composition of claim 2, wherein the sugar alcohol is xylitol and the non-digestible soluble carbohydrate is a non-indigestible oligosaccharaide.

6. The composition of claim 4, wherein the composition comprises from about 1% to 10% by weight extract from Lo Han Kuo fruit, from about 30% to about 49% by weight xylitol, and from about 50% to about 60% of an indigestible maltodextrin.

7. The composition of claim 4, wherein the composition comprises about 5% by weight extract from Lo Han Kuo fruit, about 40% by weight xylitol and about 55% by weight of a non-digestible soluble carbohydrate.

8. The composition of claim 2, wherein the sugar alcohol is selected from the group consisting of xylitol, sorbitol, maltitol and mannitol.

9. The composition of claim 2, wherein the non-digestible soluble carbohydrate is selected from the group consisting of indigestible maltodextrin, guar gum, caragennean gum, and non-digestible oligosaccharides.

10. A method for sweetening a food product comprising the step of mixing the food product with an herbal sweetener comprising extract of Lo Han Kuo fruit, a sugar alcohol and a non-digestible soluble carbohydrate.

11. The method of claim 9, wherein the herbal sweetener comprises from about 1% to 10% by weight extract from Lo Han Kuo fruit, from about 30% to about 49% by weight xylitol, and from about 50% to about 60% by weight of an indigestible maltodextrin.

12. The method of claim 10, wherein the herbal sweetener comprises from about 1% to 10% by weight extract from LoHan Kuo fruit, from about 30% to about 49% by weight xylitol, and from abut 50% to about 60% by weight of a non-digestible oligosaccharide.

13. The method of claim 11, wherein the food product is a dry mix selected from the group consisting of meal replacements, protein powders, low carbohydrate meal substitutes, low sugar meal substitutes and nutritional supplements.

14. The method of claim 11, wherein the food product is a baked product and the herbal sweetener is added prior to baking.

15. The method of claim 11, wherein the food product is selected from the group consisting of candies, bars, ice cream, and cakes.

16. The method of claim 11, wherein the food product is selected from the group consisting of tea, coffee, fruit juices, fruit drinks, smoothies, and vegetable juices.
